(19) United States
(12) Patent Application Publication
(10) Pub. No.: US 2006/0286926 A1
(43) Pub. Date: Dec. 21, 2006

(54) System for onsite program distribution

(75) Inventor: Hubert J. Schlafly, Greenwich, CT (US)

Correspondence Address: ST. ONGE STEWARD JOHNSTON & REENS, LLC, 986 BEDFORD STREET, STAMFORD, CT, 06905-5619, US

(73) Assignee: WUTP, Inc.

(21) Appl. No.: 11/157,501

(22) Filed: Jun. 21, 2005

(51) Int. Cl. H04H 1/00

(52) U.S. Cl. 455/3.01

(57) ABSTRACT

A program re-transmitting system for onsite re-transmission of a program, the re-transmitted program being received from a commercial transmission system, demodulated and re-transmitted via low-power RF signal that may be received by a standard radio. The program may further be presented to the listener as a repetitive program that ramps up in volume as the program proceeds.

### FIELD OF THE INVENTION

The system relates to a system and method for transmitting a program to a listener, and more specifically to a system and method for providing an input signal containing program content to a site and local retransmission of the program content as a broadcast frequency for the site.

### BACKGROUND OF THE INVENTION

Most if not all homes have radio broadcast receivers. In particular, the clock radio has become standard bedside equipment in many homes. Typically, the clock radio is set to turn on, whether an audible alarm or the radio receiver itself, at a particular time to wake up the individual. It is also known to provide a gradually increasing volume for the receiver to gently wake up the listener.

If the radio receiver is selected as the wake-up mechanism, the listener will generally tune the receiver to a particular frequency corresponding to a desired broadcast station to be received. Once the clock radio turns on at a selected time, the radio begins playing the audio program broadcast by the station the radio is tuned to receive.

However, listener is limited in the types of programs that can be received by the radio. For example, the listener must select a program from those broadcast by the various local stations, whether Amplitude Modulation (AM) or Frequency Modulation (FM). While a relatively large amount varied programming may be available to select from, this is not true in all areas of the country, and also certain types of programming are typically not broadcast. Repetitive programming directed to for example, religious content is typically not broadcast by local stations. Repetitive programming is typically not broadcast on local radio stations because of its nature, one would only listen to the program for a relatively short period of time, with the program repeating again and again. Therefore, this type of programming is typically not broadcast on AM or FM stations.

A large variety of programming may be accessed via, for example, the Internet. However, one typically requires a computer to access this programming. In addition, it is difficult to set the computer to receive a particular program and present that received program to a listener at a particular time. Further, any adaptation of a computer system to provide this functionality, if at all possible, would be expensive, bulky and very complicated.

Special programming can be received in one area of the house via the Internet and a computer, but that program distribution is limited to that area of the house where the computer is located and cannot be received in every room of the house. While wireless internet connections are known, these require the user to have a computer, a wireless transmitter and the computer to be equipped with a wireless card, all of which can be very expensive.

What is desired then is a system that provides for increased variety in programming presented to the listener within a restricted distance that may be played through a standard radio.

It is further desired to provide a system and method for transmitting a program to be received on a standard radio and presented to a listener in virtually any room of the home without need of running unsightly wires throughout the home.

It is still further desired to provide a system and method that provides for a repetitive radio program to be received by a listener on a standard radio that gradually increases in volume of the program from the beginning of the program cycle to gently wake the person from sleep.

It is yet further desired to provide a system and method that provides for a repetitive radio program broadcast that repeats on a predetermined schedule and that is received and presented to a listener on a standard radio.

### SUMMARY OF THE INVENTION

These and other objectives are achieved in one advantageous embodiment by the provision of a signal transducer positioned onsite, for receiving an input signal containing program content and for retransmission of the program content onsite.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or internetwork.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

It is contemplated that an incoming signal may comprise any type of desired carrier signal and signal transmitting system including but not limited to: a Cable Television Network; a Satellite Channel; the Internet; a Telephone Network; and/or a Wireless Network. Program content may be broadcast over any of these typical broadcast systems by well-know modulation and transmission techniques.

The program content may be received onsite, whether a residence or a facility, by a signal transducer that may in one advantageous embodiment, demodulate the program content from the received signal. The demodulated program content may then be retransmitted as, for example but not limited to, a relatively low-power Radio Frequency or ShortWave broadcast to be received by a standard receiver. As used herein, the term Radio Frequency or (RF) includes both radio frequency and shortwave transmission.

The program may comprise a repetitive program, meaning a program of a selected length that is broadcast over and over. Such repetitive programming does not lend itself to local radio station broadcast due to the limited scope of the program content and the repetitive nature. However, this type of specialized broadcast programming may effectively be transmitted via a number of the various transmission means previously discussed. Such broadcast programming may comprise for example, a religious program including prayer or dedication, which could be presented to the listener as a gradually increasing volume signal to gently wake the listener from sleep. The clock radio may be set to a particular broadcast frequency corresponding to the local rebroadcast signal. The alarm setting may be set to coincide with the beginning of a program broadcast cycle, for instance, comprising the ringing of distant church bells that increases in volume.

The program may last for a specific time interval such as, for example but not limited to, five minutes, with a specified dead time in between program cycles. Although the program content may normally change on a daily basis, the same message may be repeated each day during morning hours through a normal household wake-up period from, for example, 5 AM through 10 AM local time.

In one advantageous embodiment a system for onsite retransmission of a broadcast program is provided comprising, an input signal including program content transmitted over a communication network, and a signal transducer for receiving the input signal from the communication network. The system is provided such that the signal transducer extracts the program content from the input signal. The signal transducer is also provided with a transmitter circuit for retransmitting the program content. The system is further provided such that the transmitter circuit retransmits the program content as a Radio Frequency (RF) signal format for receipt by a radio.

In another advantageous embodiment a system for in-home retransmission of a broadcast audio program is provided comprising, an input audio signal including program content transmitted over a communication network, and a signal transducer for receiving the input audio signal from the communication network. The system is provided such that the signal transducer includes a demodulator for demodulating the program content from the input audio signal, and the signal transducer includes a transmitter circuit for retransmitting the program content. The system is further provided such that the transmitter circuit retransmits the program content as a Radio Frequency (RF) signal format for receipt by a radio.

In still another advantageous embodiment a method for in-home retransmission of a broadcast audio program is provided comprising the steps of, transmitting an input audio signal including program content over a communication network, and receiving the input audio signal from the communication network. The method further comprises the steps of, extracting the program content from the input audio signal, and formatting the program content for retransmission as a Radio Frequency (RF) signal. The method still further comprises the steps of, retransmitting the program content to a radio.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 2 is a block diagram according to FIG. 1 illustrating the signal transducer in greater detail.

FIG. 3 is a block diagram according to FIG. 1 illustrating one configuration of the transmission network.

FIG. 4 is a block diagram according to FIG. 1 illustrating another configuration of the transmission network.

### DETAILED DESCRIPTION OF THE DRAWINGS

Referring now to the drawings, wherein like reference numerals designate corresponding structure throughout the views.

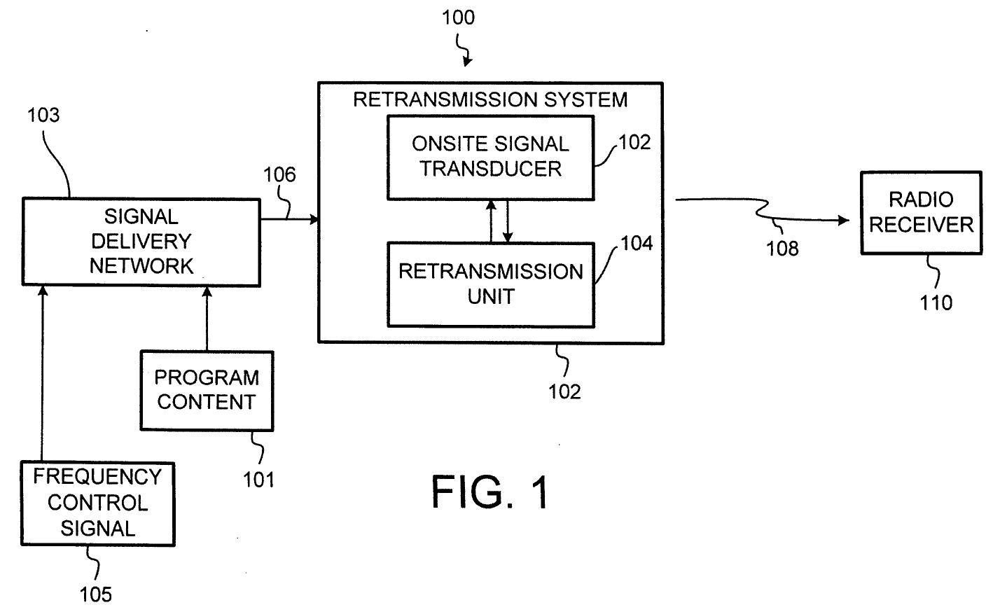

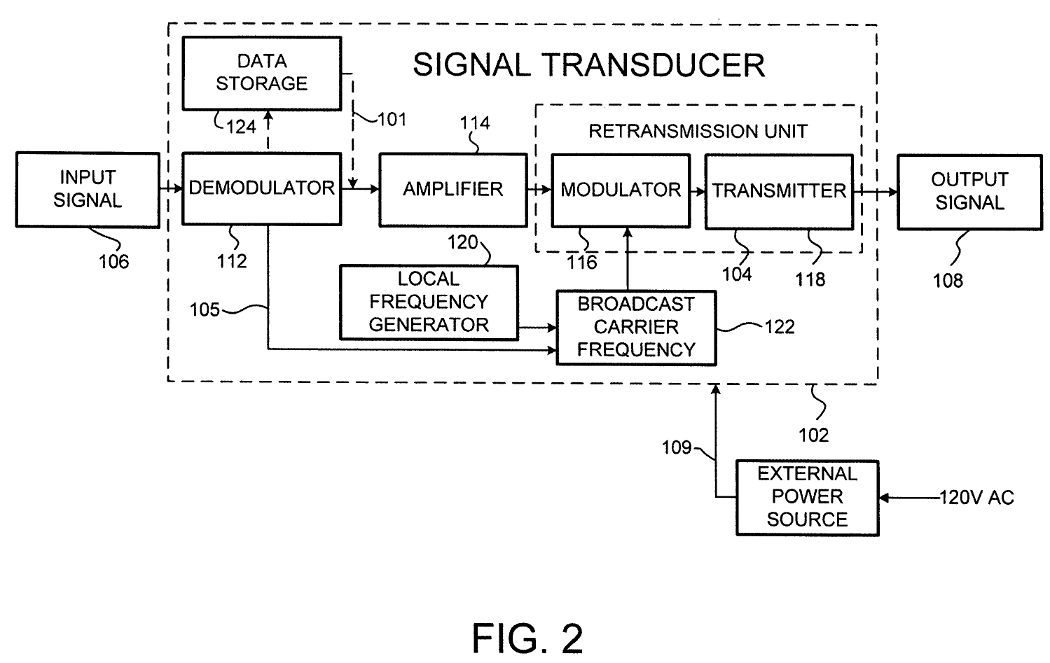

FIG. 1 depicts re-transmission system 100. Re-transmission system 100 comprises on-site signal transducer 102 which includes re-transmission unit 104. Signal transducer 102 is provided with input signal 106, which may comprise for example, program content 101 including an audio component and a signal delivery network 103. Also depicted in FIG. 1 is re-transmitted signal 108, which is illustrated as a wireless transmission signal. Finally, radio 110 is illustrated as receiving re-transmitted signal 108. The signal delivery network may also include a frequency control signal 105 which, when demodulated by demodulator 112, could alternatively replace the local frequency generator 120 shown in FIG. 2.

FIG. 2 illustrates signal transducer 102 in greater detail. In this advantageous embodiment signal transducer 102 includes, demodulator 112 and amplifier 114. Included in signal transducer 102 is re-transmission unit 104 comprising modulator 116 and transmitter 118. Also included in signal transducer 102 is frequency generator 120, which generates broadcast carrier frequency 122. Also illustrated in FIG. 2 is optional data storage 124, which is coupled to demodulator 112 and amplifier 114.

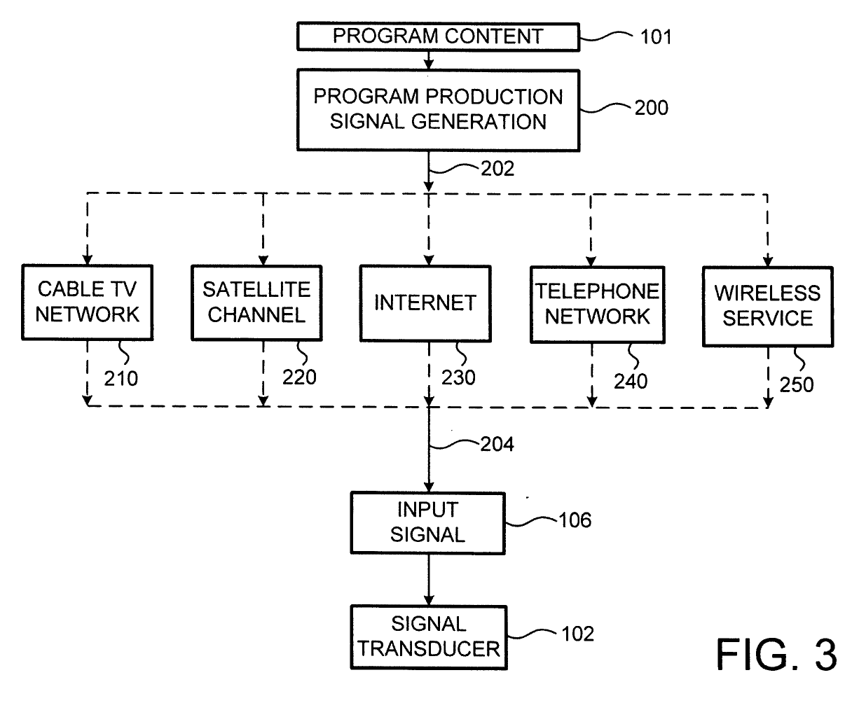

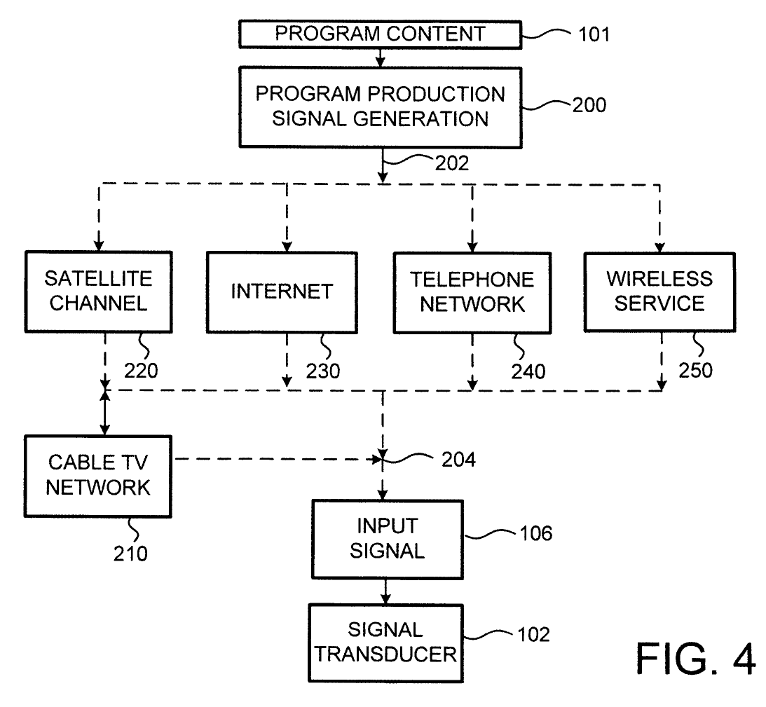

Demodulator 112 is provided to demodulate the program content 101 and possibly a frequency control signal 105 from the input signal. The input signal 106 may comprise many different formats and will be discussed further in connection with FIGS. 3 and 4. Once the program content 101 or data is extracted from input signal 106 it may be sent to amplifier 114. Once amplified to a selected signal level, program content 101 is sent to re-transmission unit 104. In this advantageous embodiment, the initial stage of the re-transmission unit 104 is modulator 116. Modulator 116 receives both program content 101 to be re-transmitted and broadcast carrier frequency 122. Frequency generator 120 generates broadcast frequency 122 which must be selected so as not to interfere with local broadcast stations. The Transmitter 118 should comply with FCC Rule 15 power limitation for Unlicensed Low Power Broadcast Service. It is contemplated that Broadcast Carrier Frequency 122 received from the local Frequency Generator 120 is preselected by the program originator for each service area. As an alternative, the frequency of the local generator may be selectable via a tuning control mounted, for instance, on the housing of the Signal Transducer 102. The selected frequency may further be provided with a digital display, such as an LCD or LED display so the user may easily see the selected rebroadcast frequency. However, allowing the user to select the broadcast frequency should comply with the Federal Communication Commission ruling that the signal transducer not interfere with licensed broadcast stations in the service area.

It is further contemplated that Input Signal 106, in addition to a carrier frequency modulated with the Program Content 101, might also carry a single frequency unique to each service area, selected by the program originator. When demodulated, this frequency becomes the Broadcast Carrier Frequency 122 in place of the local Frequency Generator 120. This removes the need and ability for the user to select a broadcast frequency which complies with the FCC requirement of non-interference with a licensed broadcast station transmission. It gives the program producer the ability to select or change the broadcast frequency for all users in a service area without the need to reprogram the signal transducer on a unit by unit basis.

Modulator 116 modulates program content 101, which is then sent to transmitter circuit 118 for re-transmission. Transmitter circuit 118 may comprise any typical relatively low-power RF transmitter. In this manner, when for example, re-transmission system 100 is used for in-home distribution, a listener may tune their bedside clock radio to the selected frequency for reception of program content 101, which is received as a standard radio frequency. Further, if consistent with the FCC power limitation, a listener may receive the program in virtually any room of the home or any location on site with a standard radio receiver. The listener would need only tune the radio receiver to the re-transmitted broadcast frequency.

It is contemplated that the signal format for output signal 108 may comprise Amplitude Modulation (AM) or Frequency Modulation (FM). This is highly advantageous because the user only has to purchase or be provided with re-transmission system 100, which may comprise a relatively low-profile housing. The listener may then utilize his/her existing radio(s) to simply tune-in to the re-transmitted signal with little effort. Additionally, the system is relatively inexpensive to manufacture and is completely self-contained. In this manner, the listener need only obtain a single re-transmission system 100 while being able to listen to the program in multiple locations via existing, inexpensive radio receivers.

As an alternative embodiment, data storage 124 may be provided to for instance, act as a buffer for program content 101. After program content is demodulated, it may be stored in data storage 124 for later playback to the listener. In this manner, the system may continuously buffer program content 101 for later or even continuous playback. This would be advantageous if an individual would like to receive program content 101 at a time that does not coincide with the standard play time of the program. For example, a listener on a different working schedule (i.e. a night schedule) may want to hear program content 101 in the afternoon when they wake up, or even in the evening time prior to work. Alternatively, an individual may simply want to hear program content 101 prior to going to bed in the evening. In any case, data storage 124 allows the listener to hear program content 101 at virtually any desired time convenient to the listener.

Electrical power for the signal transducer circuitry 102 might be provided by an internal power supply operating from standard household 120 AC voltage. However, it is preferred that an external power supply 109 readily available and used by other electronic devices, be connected to and provide low voltage DC power to the signal transducer 102. This not only reduces the circuitry in the signal transducer, it avoids the necessity of obtaining underwriter laboratory certification for such an internal supply.

Turning now to FIG. 3, various transmission system are illustrated that may be utilized in connection with the present invention. For example, program production signal generation 200 containing program content 101 is accomplished at a centralized location, in for example a production studio (not shown). Illustrated are several commercial transmission systems receiving program content 101 via communications link 202. Equipment to receive signals from these connections may be relatively expensive and unsuitable for on-site reception.

The illustrated commercial transmission systems in FIG. 3 include: a Cable TV Network 210; a Satellite Channel 220; the Internet 230; a Telephone Network 240 and/or a Wireless Network 250. It is contemplated that any one or a combination of these systems may be effectively used as a source for input signal 106. If for example, a Cable TV Network 210 is utilized, program content 101 may be modulated and transmitted over the cable lines. A coaxial cable may then be connected from, for example, a cable box, by means of a splitter, to signal transducer 102 for demodulation of program content 101. Alternatively, if Satellite Channel 220 is used, this may be coupled to a cable head-end as is commonly used in the field as shown in FIG. 4.

Dissemination link 204 provides input signal 106 which is coupled to signal transducer 102. It is contemplated that dissemination link 204 may require equipment to receive signals from some of these connections which is readily available but can be relatively expensive if required at each individual user home.

FIG. 4 illustrates and alternative embodiment for the various transmission systems. FIG. 4 is similar to the layout of FIG. 3 except Cable TV Network 210 is provided optionally in series with the other commercial transmission systems.

For example, it is contemplated that input signal 106 may be received via 204 from a Satellite Channel 220, the Internet 230, a Telephone Network 240 and/or a Wireless Network 250 directly to signal transducer 102, or, alternatively, may be transmitted by one or more of the these various commercial transmission systems in conjunction with Cable TV Network 210 which acts as a buffer for these systems. The various transmissions systems used will depend upon user location, system availability and cost. If a cable network is used as a buffer, interface with the delivery systems would be at the cable head end which serves a large area, and not at each user location.

Program content 101 may comprise virtually any audio content. In one advantageous embodiment it is contemplated that program content 101 comprises a religious message including for example, a dedication of ones first thoughts of the day to moral and spiritual values. This message may be provided to the listener as a gently increasing volume of a discrete program having a predetermined length. In one advantageous embodiment, the program may comprise distant ringing church bells that increase in volume to gently wake the listener from sleep. As the program continues, full volume is reached.

It is further contemplated that the program, which may vary on a daily basis, comprises a repetitive program format that runs for a predetermined time period (i.e., 3 or 4 minutes), concludes, and then is followed by a dead cycle of a few minutes. An individual may set the alarm to turn the radio receiver 110 on during one of the dead cycles so that no portion of the program is missed and the listener gains the benefit of the gently increasing volume of program content 101. Should the user fall asleep before arousal, the repetitive program will be heard again without the necessity of manually operating a “snooze” button. Once awakened, of course, the user has the option of tuning to other radio or television programs while actively preparing for daily chores.

Since wake up times will vary to suit the users needs, or those of other members of the household, the same daily wakeup program will be delivered to the home for an extended period of time, for example from 5 AM through 10 AM in each national time zone. It may be repeated for a similar period in the afternoon or early evening for use by night workers who sleep during the day.

It is still further contemplated that program content 101 may be provided with an imbedded signal to automatically turn on a suitable equipped radio receiver 110 rather than relying on a clock setting. This provides the advantage that the program is always presented to the listener from the start of the program as the imbedded signal from the studio turns on radio receiver 110 and, therefore, approximate synchronization of the alarm with one of the dead cycles is unnecessary.

To insure that the listener has tuned into the correct station prior to sleep, it is further contemplated that a tone or other readily identifiable audio program may advantageously be transmitted to provide confirmation to the listener that the correct frequency has been selected, prior to turning the radio off for a sleep session.

While the preferred embodiment of the invention is directed toward religious programming content to be transmitted into the home, it is contemplated that virtually any type of program content may be used in connection with the invention. For example, local, national and/or international news may be provided to the listener. Specific financial reports could be presented. Sports reports may also be presented. These are simply a few of the many types of information that may be presented to the listener for their use. It is further contemplated that any number of the various types of information may be presented to the listener in any combination, such as the program may begin with a religious message and then proceed to a news, financial, or sports report in any combination desired.

Although the invention has been described with reference to a particular arrangement of parts, features and the like, these are not intended to exhaust all possible arrangements or features, and indeed many other modifications and variations will be ascertainable to those of skill in the art.

1. A system for onsite retransmission of an audio program comprising:
an input signal including program content transmitted over a communication network;
a signal transducer for receiving said input signal from the communication network;
said signal transducer extracting the program content from said input signal;
said signal transducer including a transmitter circuit for retransmitting the program content;
said transmitter circuit retransmitting the program content as a Radio Frequency (RF) signal format for receipt by a radio; and
said communication network selected from the group consisting of: Cable TV Network; Satellite Channel; the Internet; a Telephone Network; a Wireless Service; and combinations thereof;
said signal transducer being adaptable for use with all of the communications networks.

2. The system according to claim 1 wherein said RF signal format is selected from the group consisting of: Amplitude Modulation (AM) and Frequency Modulation (FM).

3. (canceled)

4. The system according to claim 1 wherein said signal transducer further comprises a demodulator for demodulating said input signal.

5. The system according to claim 1 wherein said signal transducer further comprises an amplifier for amplifying extracted program content.

6. The system according to claim 1 wherein said signal transducer further comprises a modulator for modulating said program content for re-transmission.

7. The system according to claim 6 wherein said signal transducer further comprises a frequency generator for generating a carrier frequency for said re-transmitted program content, which can be manually or remotely tuned to select a carrier frequency in the broadcast band.

8. The system according to claim 1 wherein the program content has a pre-selected length.

9. The system according to claim 8 wherein the program content increases in volume as the program content progresses.

10. The system according to claim 8 wherein the program content is a repetitive program and is replayed at pre-selected intervals.

11. The system according to claim 1 wherein the input signal includes an additional carrier modulated single frequency which is in the RF broadcast frequency range.

12. The system according to claim 11 wherein said frequency is demodulated by the in-home signal transducer and is applied as an alternative to the local frequency generator as the broadcast carrier frequency used for retransmission.

13. A system for retransmission of an audio program comprising:
an input audio signal including program content transmitted over a communication network;
a signal transducer for receiving said input audio signal from the communication network;
said signal transducer including a demodulator for demodulating the program content from said input audio signal;
said signal transducer including a low-power transmitter circuit for retransmitting the program content; and
said transmitter circuit retransmitting the program content as a low-power Radio Frequency (RF) signal format for receipt by a local radio.

14. The system according to claim 13 wherein said RF signal format is selected from the group consisting of: Amplitude Modulation (AM); Frequency Modulation (FM); and Shortwave.

15. The system according to claim 13 wherein the communication network is selected from the group consisting of: Cable TV Network; Satellite Channel; the Internet; a Telephone Network; a Wireless Service; and combinations thereof.

16. The system according to claim 13 wherein the program content has a pre-selected length.

17. The system according to claim 16 wherein the program content increases in volume as the program content progresses.

18. The system according to claim 16 wherein the program content is a repetitive program and is replayed at pre-selected intervals.

19. A method for in-home retransmission of an audio program comprising the steps of:
transmitting an input audio signal including program content over a communication network;
receiving the input audio signal from the communication network;
extracting the program content from said input audio signal;
formatting the program content for retransmission as a low-power Radio Frequency (RF) signal; and
retransmitting the program content to a local radio.

20. The method according to claim 19 wherein the program content has a pre-selected length and is replayed at pre-selected intervals.

21. The method according to claim 19 further comprising storing the program content extracted from the input audio signal.

22. The method according to claim 19 wherein said low power Radio Frequency signal is an Amplitude Modulation (AM) signal.

23. The system according to claim 1 wherein said signal transducer further comprises a data storage for buffering the program content.

24. The system according to claim 13 wherein said signal transducer further comprises a data storage for buffering the program content.

25. A system for onsite retransmission of an audio program comprising:
an input signal including program content transmitted over a communication network;
a signal transducer for receiving said input signal from a communication network;
said signal transducer extracting the program content from said input signal;
said signal transducer including a transmitter circuit for retransmitting the program content;
said transmitter circuit retransmitting the program content as a low-power Radio Frequency (RF) signal format for receipt by a local radio;
wherein said low power Radio Frequency signal is an Amplitude Modulation (AM) signal;
wherein said signal transducer further comprises a data storage for buffering the program content.

26. The system according to claim 25 wherein the communication networks is the Internet.

27. The system according to claim 25 wherein the communication networks is a Telephone Network.

28. The system according to claim 27 wherein the program content is a repetitive program and is replayed at pre-selected intervals.
